(19) United States
(12) Patent Application Publication
(10) Pub. No.: US 2022/0379959 A1
(43) Pub. Date: Dec. 1, 2022

(54) VEHICLE, VEHICLE CONTROL SYSTEM AND VEHICLE CONTROL METHOD

(71) Applicant: PANASONIC INTELLECTUAL PROPERTY MANAGEMENT CO., LTD., Osaka (JP)

(72) Inventors: Fumio KOSUGE, Tokyo (JP); Tomoaki ABE, Kanagawa (JP); Akihisa KAWASAKI, Kanagawa (JP)

(73) Assignee: PANASONIC INTELLECTUAL PROPERTY MANAGEMENT CO., LTD., Osaka (JP)

(21) Appl. No.: 17/331,182

(22) Filed: May 26, 2021

(51) Int. Cl. B62D 15/02; G07C 5/08; G06K 9/00; G01S 13/931; G01S 19/42

(52) U.S. Cl. CPC B62D 15/025; G07C 5/0816; G06K 9/00798; G01S 13/931; G01S 19/42; G01C 21/36

(57) ABSTRACT

A vehicle includes a processor, a memory having instructions, and an output device. The instructions, when executed by the processor, cause the vehicle to perform operations including: detecting a boundary line of the lane on which the vehicle is running; estimating a center position of the lane on which the vehicle is running on the basis of the detected boundary line; calculating an offset indicating a displacement in a vehicle width direction from the center position of the lane in accordance with the estimated center position of the lane and a vehicle width such that the offset varies dynamically; performing a steering control in the vehicle width direction on the basis of the offset; and generating notification information for announcing a content of the steering control.

### FIELD

The present disclosure relates to a vehicle, a vehicle control system, and a vehicle control method.

### BACKGROUND ART

JP-A-H09-062346 discloses a technique for suppressing formation of ruts in a road.

### SUMMARY

Incidentally, techniques for controlling the running of a vehicle so as to prevent formation of ruts in a road or not to deteriorate the state of ruts already formed in a road are now desired.

The concept of the present disclosure has been conceived in view of the above circumstances in the art, and an object of the disclosure is therefore to provide a vehicle, a vehicle control system, and a vehicle control method capable of setting adaptively an offset from the center position of a lane of the road that is suitable for each running vehicle and presenting a running state to the driver, and thereby suppressing formation of ruts.

The disclosure provides a vehicle configured to run on a road including at least one lane, the vehicle including: a processor; a memory having instructions; and an output device, wherein the instructions, when executed by the processor, cause the vehicle to perform operations, the operations including: detecting a boundary line of the lane on which the vehicle is running; estimating a center position of the lane on which the vehicle is running on the basis of the detected boundary line; calculating an offset indicating a displacement in a vehicle width direction from the center position of the lane in accordance with the estimated center position of the lane and a vehicle width such that the offset varies dynamically; performing a steering control in the vehicle width direction on the basis of the offset; generating notification information for announcing a content of the steering control; and causing the output device to output the generated notification information.

The disclosure also provides a vehicle control method of a vehicle configured to run on a road including at least one lane, the vehicle control method including: detecting a boundary line of the lane on which the vehicle is running; estimating a center position of the lane of the road on the basis of the detected boundary line; calculating an offset indicating a displacement in a vehicle width direction from the center position of the lane in accordance with the estimated center position of the lane and a vehicle width such that the offset varies dynamically; performing a steering control in the vehicle width direction on the basis of the offset; and generating notification information for announcing a content of the steering control and outputting the notification information.

Furthermore, the disclosure provides a vehicle control system including: a vehicle including a first processor, a first memory having first instructions, and a first communication device, the vehicle being configured to run on a road having at least one lane; and a server including a second processor, a second memory having second instructions, the first communication device, and a second communication device, wherein the first instructions, when executed by the first processor, cause the vehicle to perform first operations, the first operations including: detecting information relating to a running position on a road on which the vehicle is running and a boundary line of the lane of the road; estimating a center position of the lane on the basis of the detected boundary line; calculating an offset indicating a displacement in a vehicle width direction from the center position of the lane in accordance with the estimated center position of the lane and a vehicle width of the vehicle; generating vehicle information including the information relating to the running position of the vehicle and the calculated offset; and causing the first communication device to transmit the vehicle information to the server, wherein the second instructions, when executed by the second processor, cause the server to perform second operations, the second operations including: acquiring vehicle information of another vehicle running in a range of a prescribed distance from the vehicle in a running interval including the running position of the vehicle, the running position being received via the second communication device; calculating an updated offset containing a difference between the offset corresponding to the vehicle and an offset corresponding to the another vehicle included in the vehicle information of the another vehicle, the difference being larger than or equal to a prescribed value; and causing the second communication device to transmit the updated offset to the vehicle, and wherein the first operations further include performing a steering control on the vehicle on the basis of the updated offset received via the first communication device.

Still further, the disclosure provides a vehicle control method performed by a vehicle control system in which a vehicle configured to run running on a road including at least one lane and a server are configured to communicate with each other, the vehicle control method including: detecting information relating to a running position on a road on which the vehicle is running and a boundary line of the lane of the road; estimating a center position of the lane on the basis of the detected boundary line; acquiring an offset indicating a displacement in a vehicle width direction from the estimated center position of the lane; acquiring current vehicle information of another vehicle that is running in a range of a prescribed distance from the vehicle in a running interval including the running position of the vehicle; calculating an updated offset containing a difference between the offset corresponding to the vehicle and an offset corresponding to the another vehicle included in the vehicle information of the another vehicle, the difference being larger than or equal to a prescribed value; and performing a steering control on the vehicle on the basis of the calculated updated offset.

According to the present disclosure, it is possible to adaptively set an offset from the center position of a current lane of the road that is suitable for each running vehicle and presenting a running state to the driver, which can suppress formation of ruts.

### BRIEF DESCRIPTION OF DRAWINGS

FIG. 1 is a view showing an example road;

FIG. 2 is a view showing an example vehicle;

FIG. 3 is a block diagram showing an example internal configuration of the vehicle according to the first embodiment;

FIG. 4 is a flowchart showing an example control process to be executed by the vehicle according to the first embodiment;

FIG. 5 is an explanatory diagram showing an example system configuration of a vehicle control system according to a second embodiment;

FIG. 6 is a sequence diagram showing an example control process of the vehicle control system according to the second embodiment;

FIG. 7 is an explanatory diagram showing an example steering control;

FIG. 8 shows an example manner of output of notification information;

FIG. 9A shows an example manner of output of notification information (center position);

FIG. 9B shows an example manner of output of notification information (leftward displacement); and

FIG. 9C shows an example manner of output of notification information (rightward displacement).

### DETAILED DESCRIPTION

### Introduction to Conception of Contents of Embodiment 1

In recent years, a vehicle control system has been being desired that controls the steering of a vehicle automatically to suppress a phenomenon that ruts are formed in roads because vehicles run at the same position of each road. Such a vehicle control system varies the center of a vehicle running on a road (in other words, the center of the vehicle in its width direction) with respect to the center position of a current lane of the road (in other words, the center position in the road width direction) and thereby causes distribution of weight loads produced by running vehicles. In this manner, the vehicle control system can distribute positions of ruts formed in each road (in other words, deterioration positions of each road).

For example, autonomous drive vehicles are known as vehicles to which such a vehicle control system can be applied. For autonomous drive vehicles, autonomous driving levels (described later) were defined on 2016 by NHTSA (National Highway Traffic Safety Administration) which is one organization of the U.S. Department of Transportation. The autonomous driving levels are discriminated from each other on the basis of whether a human or the autonomous driving system of a vehicle is mainly in charge of monitoring of a drive environment. The autonomous driving levels will be described below.

At autonomous driving level “0,” a human performs driving fully (in other words, there is no automated driving). At autonomous driving level “1,” the autonomous driving system of a vehicle sometimes assists a human driver and performs several drive controls. At autonomous driving level “2,” the autonomous driving system of a vehicle performs several drive controls. At autonomous driving level “2,” a human monitors a drive environment. At autonomous driving level “3,” the autonomous driving system of a vehicle performs several drive controls and monitors a drive environment in certain situations. In addition, as for the monitoring of a drive environment at autonomous driving level “3,” a human needs to perform driving if he or she is requested to do so by the autonomous driving system of the vehicle. At autonomous driving level “4,” the autonomous driving system of a vehicle performs drive controls and monitors a drive environment. In addition, at autonomous driving level “4,” the autonomous driving system can perform drive controls without driving by a human in a certain environment or under certain conditions. At autonomous driving level “5,” the autonomous driving system can perform all drive controls under the same conditions as for a human.

Since autonomous drive vehicles as mentioned above are considered to spread in the future, it is highly probable that the proportion of autonomous drive vehicles in vehicles running on roads will increase. Each of such vehicles detect boundary lines of a load (or lane) and runs along the detected boundary lines. Thus, if the proportion of autonomous drive vehicles increases, it is expected that the rates of formation of ruts in roads (in other words, the rates of deterioration of roads) will become higher than in the case of only conventional vehicles because the number of vehicles running at the same positions along boundary lines will increase.

As seen from the above, to suppress formation of ruts in roads, a vehicle control system is desired that varies the center of each vehicle running on a road by setting a prescribed displacement (offset) for the vehicle. In view of this, in the following first embodiment, examples of a vehicle, a vehicle control system, and a vehicle control method capable of setting adaptively an offset, from the center position of a lane of a road, suitable for each of running vehicles including autonomous drive vehicles of autonomous driving level “2” or higher, presenting a running state to the driver, and thereby suppressing formation ruts.

Embodiment as specific disclosures of configurations and workings of a vehicle, a vehicle control system, and a vehicle control method according to the present disclosure will be hereinafter described in detail by referring to the accompanying drawings when necessary. However, unnecessarily detailed descriptions may be avoided. For example, detailed descriptions of already well-known items and duplicated descriptions of constituent elements having substantially the same ones already described may be omitted. This is to prevent the following description from becoming unnecessarily redundant and thereby facilitate understanding of those skilled in the art. The following description and the accompanying drawings are provided to allow those skilled in the art to understand the disclosure thoroughly and are not intended to restrict the subject matter set forth in the claims.

### Embodiment 1

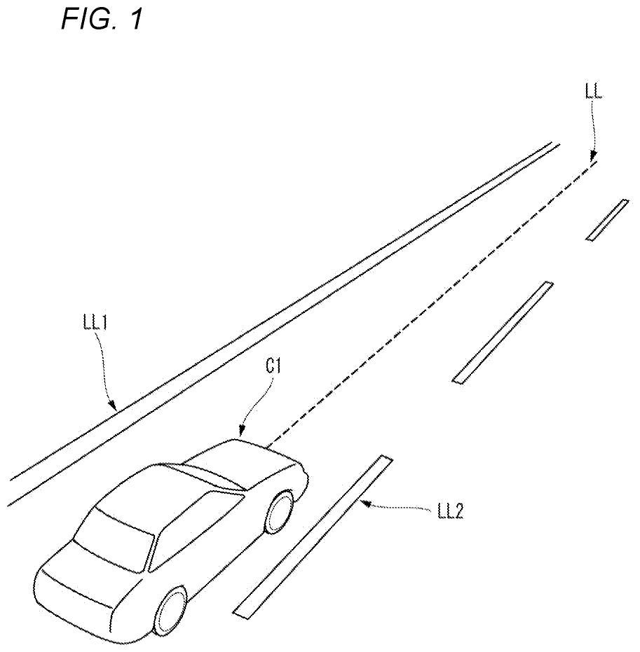

FIG. 1 is a view showing an example road. The road is provided with boundary lines LL1 and LL2 and a center position LL of a lane. Although an example road having one lane on each side is shown in FIG. 1 to simplify the description, the following description will also apply to a road having plural lanes on one side. In addition, the following description will be directed to the lane, on which a vehicle C1 is to run, of the road.

As shown in FIG. 1, the vehicle C1 runs on the road that is bounded by the boundary lines LL1 and LL2. The center position LL of the lane indicates a physical center position, in the width direction, of the road bounded by the boundary lines LL1 and LL2.

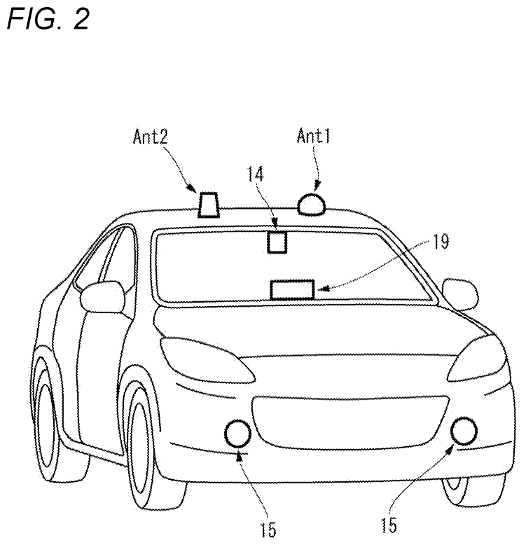

FIG. 2 is a view showing an example vehicle C1. The vehicle C1 is configured so as to include a camera 14, millimeter-wave radars 15, an output unit 19 which is an example of the term “output device,” a radio circuit antenna Ant1, and a satellite positioning antenna Ant2.

The camera 14, which is an example of the term “boundary lines detection unit” is a camera having an imaging device such as a CCD (charge-coupled device) or a CMOS (complementary metal-oxide-semiconductor) sensor. Installed so as to be able to shoot a road environment ahead of the vehicle C1, the camera 14 shoots the boundary lines LL1 and LL2 of the road (lane) on which the vehicle C1 is running. Capable of performing image processing using data of an image taken, the camera 14 detects presence/absence of the boundary lines LL1 and LL2 by the image processing and detects a distance between the detected boundary lines LL1 and LL2 (in other words, a width road within which the vehicle C1 can run). The camera 14 outputs detection results of the boundary lines LL1 and LL2 and the detected distance between the boundary lines LL1 and LL2 to a detection unit 111.

Plural millimeter-wave radars 15, which are an example of the term “boundary lines detection unit,” are installed in the vehicle C1 at bottom-front positions. The millimeter-wave radars 15 are vehicular radars that use a millimeter-wave wavelength range 1-10 mm (frequency range 30-300 GHz). The millimeter-wave radars 15 measure a distance to a target object and a direction in which the target object exists by receiving a reflection signal of the radio wave radiated around the vehicle C1. The millimeter-wave radars 15 have a measurable distance range 100-200 m and measurement accuracy 0.1 mm. The millimeter-wave radars 15 detect the boundary lines LL1 and LL2 of the road (lane) on which the vehicle C1 is running with high accuracy and also detects a distance between the detected boundary lines LL1 and LL2 (in other words, a road width in which the vehicle C1 can run). The millimeter-wave radars 15 output detection results of the boundary lines LL1 and LL2 and the detected distance between the boundary lines LL1 and LL2 to the detection unit 111.

The output unit 19 is configured so as to be able to output an image, a video, or a sound. The output unit 19 outputs notification information generated by a steering information generation unit 115 described later, which is an example of the term “notification information generation unit.”

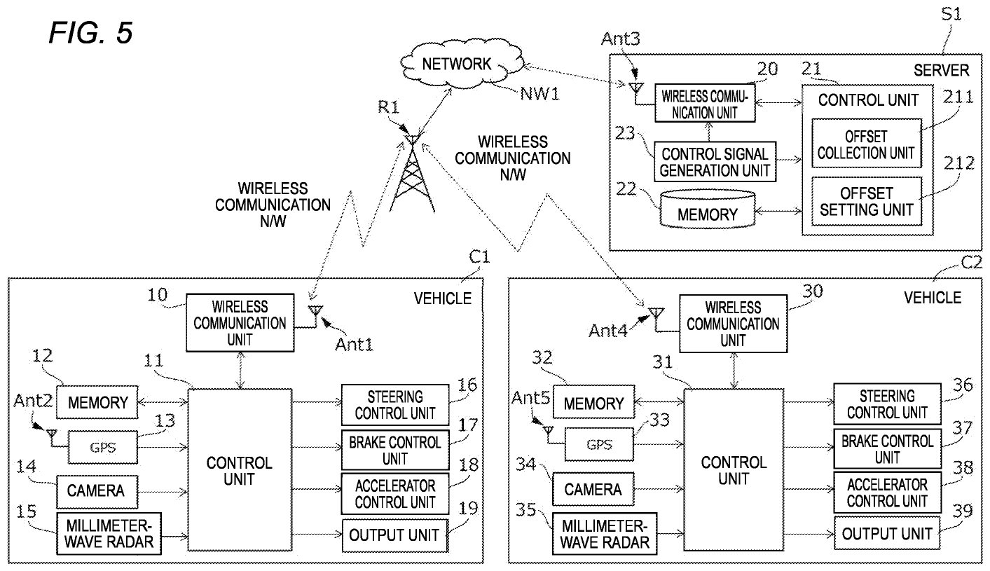

The radio circuit antenna Ant1 transmits and receives a signal to and from a base station R1 (see FIG. 5) over a wireless communication N/W (network). The wireless communication N/W is a network that is provided according to a wireless communication standard such as a wireless LAN (local area network), a wireless WAN (wide area network), a 4G (fourth generation mobile communication system), a 5G (fifth generation mobile communication system), or WiFi (registered trademark).

The satellite positioning antenna Ant2 is an antenna capable of receiving satellite positioning signals transmitted from artificial satellites (not shown). Signals that can be received by the satellite positioning antenna Ant2 are not limited signals of GPS (Global Positioning System) of the U.S. and may be, for example, signals that are transmitted from artificial satellites that can provide a satellite positioning service such as GLONASS (Global Navigation Satellite System) of Russia or Galileo of Europe. Furthermore, the satellite positioning antenna Ant2 may be an antenna capable of receiving signals from quasi-zenith satellites that transmit satellite positioning signals capable of reinforcing or correcting satellite positioning signals transmitted from the artificial satellites that provide one of the above satellite positioning services.

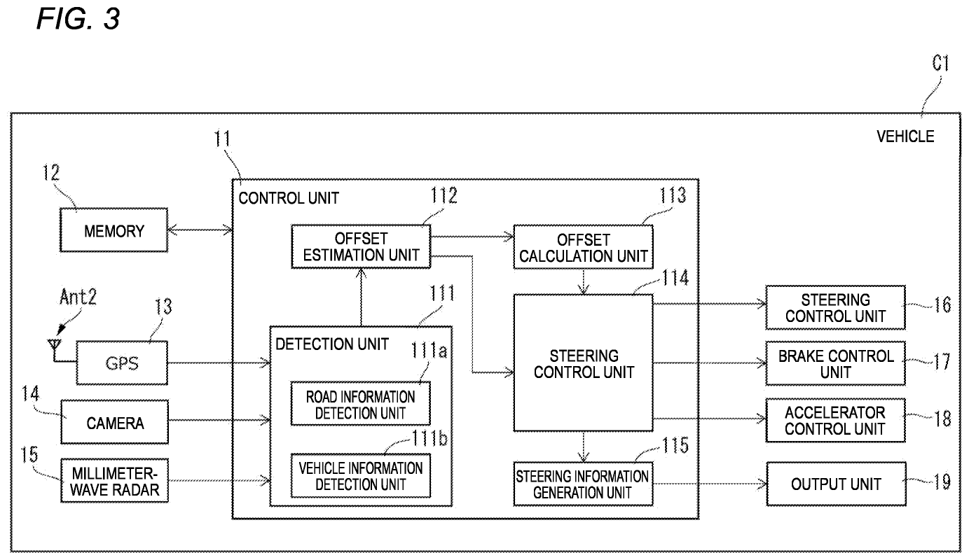

FIG. 3 is a block diagram showing an example internal configuration of the vehicle C1 according to the first embodiment. The vehicle C1 is configured so as to include a control unit 11, a memory 12, a GPS receiver 13, the camera 14, the millimeter-wave radars 15, a steering control unit 16, a brake control unit 17, an accelerator control unit 18, and the output unit 19.

The control unit 11 performs various kinds of processing and control in a centralized manner by cooperating with the memory 12. For example, the control unit 11 is configured using an ECU (electronic control unit) which is an electronic circuit control device. More specifically, the control unit 11 realizes various functions of the respective units by referring to programs and data held by the memory 12 and running the programs. The control unit 11 includes various units that are a detection unit 111, an offset estimation unit 112, an offset calculation unit 113, a steering control unit 114, and a steering information generation unit 115.

The memory 12 has a RAM (random access memory) as a work memory that is used when, for example, the control unit 11 performs each kind of processing and a ROM (read-only memory) that stores programs that describe how the control unit 11 should operate and necessary data. The RAM is stored temporarily with data or information generated or acquired by the control unit 11. Programs that describe operations of the control unit 11 (e.g., an operation of estimating a current offset of the vehicle C1 from offsets that were calculated in the past and an operation of calculating a latest offset on the basis of a center position LL of the lane on which the vehicle C1 is running at present and the width of the vehicle C1) are written in the ROM. The memory 12 is stored with a type, a width, offsets that were set in the past, etc. of the vehicle C1.

The GPS receiver 13, which is an example of the term “boundary lines detection unit,” includes the satellite positioning antenna Ant2, and receives satellite positioning signals from artificial satellites (not shown) and detects a running position of the vehicle C1. The GPS receiver 13 outputs information of the detected position of the vehicle C1 to the detection unit 111. Signals that can be received by the GPS receiver 13 are not limited signals of GPS (Global Positioning System) of the U.S. and may be, for example, signals that are transmitted from artificial satellites that can provide a satellite positioning service such as GLONASS (Global Navigation Satellite System) of Russia or Galileo of Europe. Furthermore, the GPS receiver 13 may receive signals from quasi-zenith satellites that transmit satellite positioning signals capable of reinforcing or correcting satellite positioning signals transmitted from the artificial satellites that provide one of the above satellite positioning services.

The camera 14, which is an example of the term “boundary lines detection unit,” shoots each of boundary lines LL1 and LL2 of the road (lane) on which the vehicle C1 is running. The camera 14 is capable of performing image processing using data of an image taken, and detects presence/absence of boundary lines LL1 and LL2 by the image processing and detects a distance between the detected boundary lines LL1 and LL2 (in other words, a road width within which the vehicle C1 can run). The camera 14 outputs information of the detected boundary lines LL1 and LL2 and the detected distance between the boundary lines LL1 and LL2 to the detection unit 111.

The millimeter-wave radars 15, which are an example of the term “boundary lines detection unit,” are installed in the vehicle C1 at bottom-front positions and detect respective boundary lines LL1 and LL2 of the road (lane) on which the vehicle C1 is running. The millimeter-wave radars 15 output detection results of the respective boundary lines LL1 and LL2 to the detection unit 111.

The detection unit 111 includes a road information detection unit 111a and a vehicle information detection unit 111b. The detection unit 111 acquires information of a running position of the vehicle C1 that is input from the GPS receiver 13 and information relating to the boundary lines LL1 and LL2 of the road (lane) on which the vehicle C1 is running (more specifically, whether the boundary lines LL1 and LL2 exist and a road width within which the vehicle C1 can run that is determined on the basis of a distance between the boundary lines LL1 and LL2) that is input from the camera 14 or the millimeter-wave radars 15.

The road information detection unit 111a, which is an example of the term “center position estimation unit,” detects information relating to the road on which the vehicle C1 is running on the basis of data or information that is input from each (set of) of the GPS receiver 13, the camera 14, and the millimeter-wave radars 15. More specifically, the information relating to the road is information including position information of the road and a width of the road (lane). The road information detection unit 111a outputs the detection results to the offset estimation unit 112.

Furthermore, the road information detection unit 111a may be stored with map data including information relating to roads on which the vehicle C1 may run and geographical features around them. The map data may be either stored in the memory 12 of the vehicle C1 or acquired from a server (not shown) stored with map data over the wireless communication N/W using the radio circuit antenna Ant1 when it is used. The term “map data” as used herein includes at least information relating to roads and intersections, and the information relating to roads is stored on a section-by-section basis. For example, the information relating to roads is information such as the number of lanes of each road and widths of each road and boundary lines of each road (lane), and may have information of a width of each road within which a vehicle can run in the case where the road does not have boundary lines.

A method by which the road information detection unit 111a detects information relating to the road on which the vehicle C1 is running on the basis of the contents of data or information that is input from related units, that is, the GPS receiver 13, the camera 14, and the millimeter-wave radars 15, will be described below.

The road information detection unit 111a detects information relating to the road on which the vehicle C1 is running by referring to the map data on the basis of a running position of the vehicle C1 acquired from satellite positioning information received from the GPS receiver 13. The road information detection unit 111a estimates a center position LL of the lane from the detected information relating to the road. A center position LL of the lane is estimated by referring to the distance between the boundary lines LL1 and LL2 or the above-mentioned map data. The road information detection unit 111a can estimate a center position LL of the lane even in the case where the road has only one of the boundary lines LL1 and LL2 or has no boundary lines if the map data includes information of road widths in advance.

Furthermore, the road information detection unit 111a estimates a center position LL of the lane on which the vehicle C1 is running on the basis of the distance between the boundary lines LL1 and LL2 that has been input from the camera 14.

The road information detection unit 111a estimates a center position LL of the lane on which the vehicle C1 is running also on the basis of the distance between the boundary lines LL1 and LL2 that has been input from the millimeter-wave radars 15. The road information detection unit 111a can estimate a center position LL of the lane on the basis of detection results of the millimeter-wave radars 15 even in the case where the road has only one of the boundary lines LL1 and LL2 or has no boundary lines, and can estimate a center position LL on the basis of an estimation result.

The road information detection unit 111a can estimate a center position LL of the lane in the above-described manner. The method by which the road information detection unit 111a estimates a center position LL of the lane is not limited to the above-described example.

For example, the road information detection unit 111a may estimate a road width by detecting position information of the vehicle by means of the GPS receiver 33 and detecting the boundary lines LL1 and LL2 by the millimeter-wave radars 15. Furthermore, to secure necessary reliability of a detection result, the respective road information detection unit 111a may configured so as to be able to select a detection method that is suitable for a road environment (e.g., it is raining, the road is shrouded in a thick mist, or it is night) in which the vehicle C1 is running or employ a detection method that uses the camera 14 and the millimeter-wave radars 15 in combination.

The vehicle information detection unit 111b detects information relating to the vehicle C1 including a preset type and width of the vehicle C1. The vehicle information detection unit 111b may be stored with, for example, information of a road interval over which the vehicle C1 has run with a current offset obtained on the basis of offsets calculated before. The vehicle information detection unit 111b outputs the detected information relating to the vehicle C1 to the offset estimation unit 112. The information relating to the vehicle C1 including its type, width, etc. may be stored in the memory 12.

A description will now be made of the offset.

The offset is a movement length (displacement) in the vehicle width direction by which to deviate the vehicle C1 in the vehicle width direction from the center LL of the lane to prevent formation of ruts in the road on which the vehicle C1 is running or not to worsen the states of ruts already formed. That is, the offset is a difference (length) between the center LL of the lane on which the vehicle C1 is running and a position on the road at which the vehicle C1 is running currently. The term “offset” includes a preceding (or current) offset and a latest offset. A maximum offset value is calculated on a vehicle-by-vehicle basis according to a width of the road on which the vehicle C1 is running currently and the width of the vehicle C1.

The term “preceding (or current) offset” means an offset that was calculated by the offset calculation unit 113 before the present time according to a difference between a center position LL of a lane on which the vehicle C1 is running currently and the center in the vehicle width direction of the road (lane) at which the vehicle C1 is running currently and that is used currently.

The term “latest offset” means an offset that is calculated and set by the offset calculation unit 113 for a road interval including a current running position of the vehicle C1 at estimation timing (described later) for estimation of an offset.

The term “offset” may further include an offset of near future. The term “offset of near future” means an offset that is estimated by the offset estimation unit 112 for a road interval including a running position at which the vehicle C1 is scheduled to run at a time that is a little later than the current time (i.e., near future). The offset of near future is an offset that is estimated to judge whether it is appropriate for the vehicle C1 to run in the future in the road interval including a running position at which the vehicle C1 is scheduled to run in a state that the preceding or latest offset is maintained. The offset of near future makes it possible to prevent an event that the vehicle C1 runs also outside the boundary lines LL1 and LL2 (e.g., in the opposite lane or a side strip (sidewalk)). The above-mentioned road interval including a running position at which the vehicle C1 is scheduled to run at a time of near future (mentioned above) may be set along a route to a destination, set in a navigation device (not shown) in advance, of the vehicle C1 installed in the vehicle C1 or a road interval that follows a current road interval a prescribed distance ahead.

The “road interval” mentioned above may be either a prescribed interval that is one of intervals divided off every different road width or a prescribed interval that is one of intervals divided off every prescribed distance. Or the road interval may be a prescribed interval that is one of intervals divided off every different road width of a road type (e.g., national road, prefectural road, or private road) or an interval obtained every time an intersection having traffic lights appears.

The offset estimation unit 112 receives information relating to roads from the road information detection unit 111a and receives information relating to the vehicle C1 from the vehicle information detection unit 111b. The offset estimation unit 112 estimates a preceding offset on the basis of these received pieces of information according to the difference between a center position LL of the lane on which the vehicle C1 is running at present and the center of the vehicle C1 in its width direction. The offset estimation unit 112 outputs the information relating to roads, the information relating to the vehicle C1, and the estimated current offset to the offset calculation unit 113.

Furthermore, the offset estimation unit 112 may judge whether the vehicle C1 can run with the preceding offset on the basis of the information relating to roads received from the road information detection unit 111a and the information relating to the vehicle C1 received from the vehicle information detection unit 111b. The offset estimation unit 112 can calculate a maximum offset value with which the vehicle C1 can run on the basis of the received road width and width of the vehicle C1. If judging that the preceding offset is larger than the calculated offset with which the vehicle C1 can run, the offset estimation unit 112 outputs, to the offset calculation unit 113, a control signal for causing it to calculate a latest offset.

If a destination, route information, or the like is set in advance in a navigation device (not shown) installed in the vehicle C1, the offset estimation unit 112 may judge whether the vehicle C1 can run in a state that the preceding offset is maintained for a route candidate that is predictable as a route the vehicle C1 will take. If the judgment result is “impossible to run so,” the offset estimation unit 112 outputs, to the offset calculation unit 113, a control signal for causing it to calculate a latest offset for the route candidate. This allows the vehicle C1 to continue to run safely without running in such a manner as to stick out of the current road, running on a side strip such as gutter lids of the road, or running in a similar manner even in a case that the width of a road to run on has decreased. Furthermore, the offset estimation unit 112 may judge whether the vehicle C1 can run on a road interval ahead that follows the current road interval in a state that the current offset is maintained.

Furthermore, when the vehicle C1 is running on a road having no boundary lines or having only one of the boundary lines LL1 and LL2, the offset estimation unit 112 may output, to the offset calculation unit 113, a control signal for causing it to reset the offset (in other words, make the offset equal to 0). This allows the vehicle C1 to continue to run safely because of resetting of the offset even in a case that a road width is unknown. A road having no boundary lines or having only one of the boundary lines LL1 and LL2 may be detected by or using one of the GPS receiver 13, the camera 14, the pair of millimeter-wave radars 15, and the map data.

The timing when the above-mentioned offset estimation unit 112 estimates an offset may be not only timing when information relating to roads and information relating to the vehicle C1 are input to it but also, for example, timing when the vehicle C1 has passed a point that is set in the map data in advance (e.g., timing when the vehicle C1 has passed a point of position information represented by a latitude and longitude or timing when as for the above-mentioned prescribed interval switching is made from the prescribed interval in which the vehicle C1 is running currently to another prescribed interval).

The offset calculation unit 113 calculates a latest offset on the basis of input information relating to the road on which the vehicle C1 is running at present and information relating to the vehicle C1. The offset calculation unit 113 may calculate an offset so that it varies dynamically on the basis of input information relating to the road on which the vehicle C1 is running at present and information relating to the vehicle C1. The offset calculation unit 113 calculates a latest offset at timing when it receives a control signal for causing it to calculate a latest offset from the offset estimation unit 112 or timing when the received information relating to the road on which the vehicle C1 is running at present and information relating to the vehicle C1 come to satisfy a preset condition. The term “preset condition” as used herein means, for example, a condition that relates to the elapsed time from preceding calculation of an offset or the running distance from preceding calculation of an offset or a condition that the road width detected by the camera 14 and the millimeter-wave radars 15 has changed, that is, a condition other than input of a control signal generated by the offset estimation unit 112. This allows the offset calculation unit 113 to calculate an offset so that it varies dynamically. The offset calculation unit 113 outputs the calculated latest offset to the steering control unit 114.

The offset calculation unit 113 calculates a maximum offset value that allows the vehicle C1 to run on the basis of received information relating to the road on which the vehicle C1 is running and information relating to the vehicle C1. The offset calculation unit 113 calculates a latest offset within such a range as not to exceed the maximum value.

An offset calculation method of the offset calculation unit 113 will now be described.

The offset is a value that is calculated on the basis of a random number that is determined by timing of supply of power to the control unit 11 of the vehicle C1 (in other words, timing of engine activation by a person who is going to drive the vehicle C1) and the product of plural numerical values including a predetermined value of each vehicle (e.g., an optional value that is set for each vehicle type, each vehicle width, or the like), a predetermined value of each road node (e.g., an optional value that is set for each road width, each road type, or the like), and an optional numerical value set for each intersection or point and that is smaller than a maximum value indicating a range that allows the vehicle C1 to run safely. It goes without saying that the plural numerical values used for calculation of an offset is not limited to the ones mentioned above.

The steering control unit 114 calculates a steering amount with which to perform a steering control on the basis of a latest offset received newly or the difference between the latest offset and a preceding offset. The steering control unit 114 generates control signals for execution of steering controls on the vehicle C1 on the basis of the calculated offset. The control signals are transmitted to a steering actuator of the steering control unit 16, a brake actuator of the brake control unit 17, and an accelerator actuator of the accelerator control unit 18, respectively.

The steering control unit 16 performs a steering control according to the calculated latest offset or the difference between the latest offset and the preceding offset in the control signal generated by the steering control unit 114. In other words, the steering control unit 16 performs a steering control so as to decrease the difference between the latest offset and the preceding offset to 0.

The brake control unit 17 performs deceleration processing that is necessary for the steering control that is performed according to the calculated latest offset or the difference between the latest offset and the current offset in the control signal generated by the steering control unit 114.

The accelerator control unit 18 performs acceleration processing that is necessary for the steering control that is performed according to the calculated latest offset or the difference between the latest offset and the current offset in the control signal generated by the steering control unit 114.

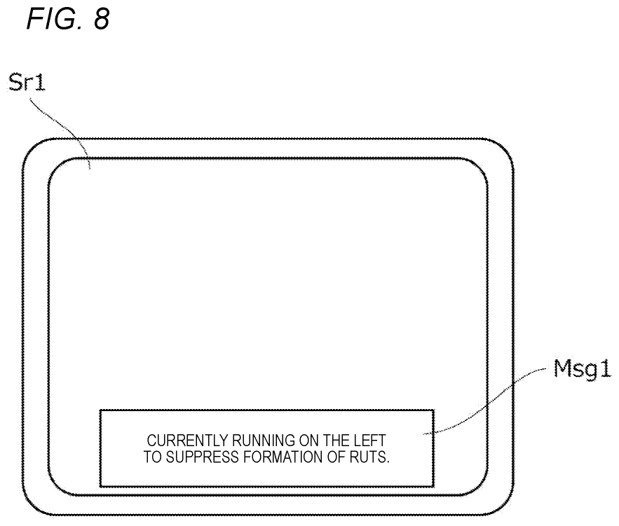

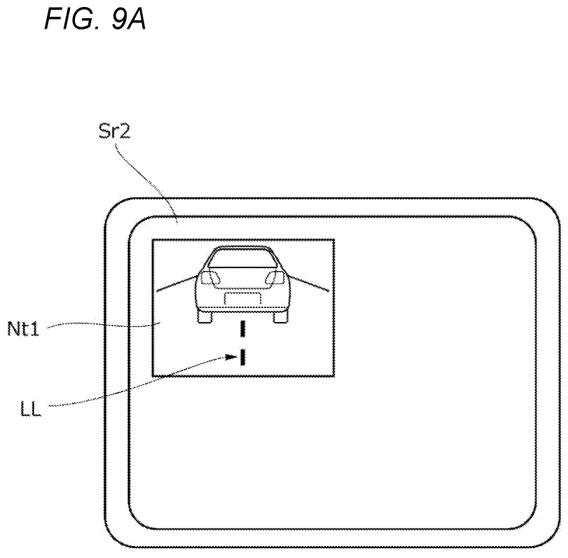

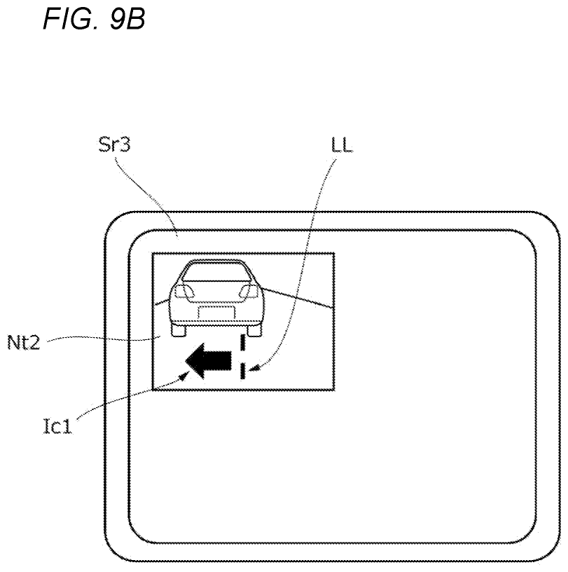

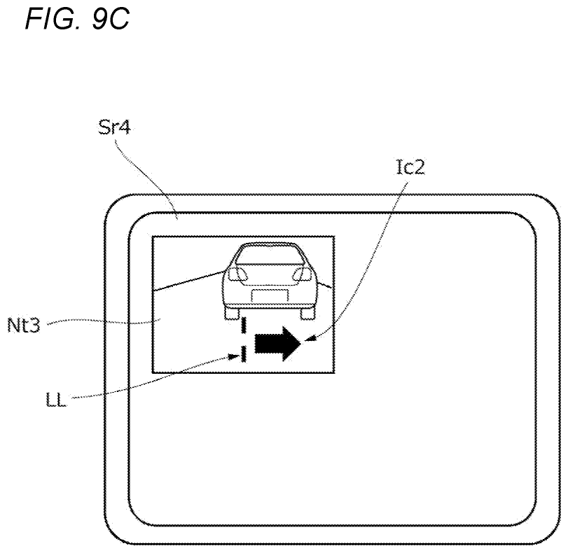

The steering information generation unit 115, which is an example of the term “notification information generation unit,” generates notification information relating to the steering control over the vehicle C1 on the basis of the steering amount calculated by the steering control unit 114. The steering information generation unit 115 outputs the generated notification information to the output unit 19 to announce it. For example, to steer the vehicle C1 to the left of the center position LL of the lane by the steering control, the steering information generation unit 115 generates and outputs notification information as shown in FIGS. 8 and 9B. The generated notification information of the steering control is not limited to an image or a text and may include a voice.

The output unit 19 makes an announcement by outputting the received notification information relating to the steering control. Equipped with a monitor capable of displaying an image, the output unit 19 announces the notification information in the form of an image including text information. The output unit 19 may be equipped with a speaker capable of voice output and announce the notification information in the form of a voice. Example manners of output of notification information will be described later.

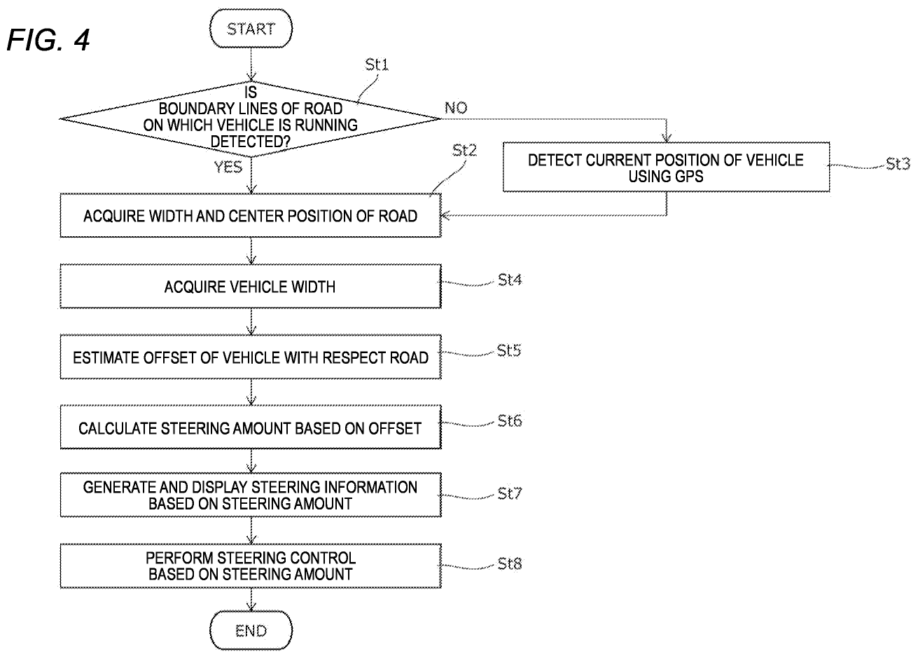

FIG. 4 is a flowchart showing an example control process to be executed by the vehicle C1 according to the first embodiment. The control process for controlling the vehicle C1 will be described with reference to FIG. 4. The control process shown in FIG. 4 calculates a latest offset at timing when a control signal for calculation of a latest offset is input from the offset estimation unit 112 or at timing when input information relating to the road on which the vehicle C1 is running at present and information relating to the vehicle C1 causes satisfaction of a preset condition. For example, the preset condition is a condition that relates to the elapsed time from preceding calculation of an offset or the running distance from preceding calculation of an offset or a condition that the road width detected by the camera 14 and the millimeter-wave radars 15 has changed. The control process shown in FIG. 4 is executed by the vehicle C1 at such timing.

The vehicle C1 judges whether the boundary lines LL1 and LL2 of the road (lane) on which the vehicle C1 is running at present are detected by the camera 14 or the millimeter-wave radars 15 (SU). To increase the reliability, the vehicle C1 may make a judgment by detecting the boundary lines LL1 and LL2 by both of the camera 14 and the millimeter-wave radars 15. The vehicle C1 may judge whether the boundary lines LL1 and LL2 are detected by a detection method that is determined according to a road environment (e.g., it is raining, the road is shrouded in a thick mist, or it is night) in which the vehicle C1 is running.

The vehicle C1 measures a width of the road (lane) by measuring a distance between the boundary lines LL1 and LL2, detected by the camera 14 or the millimeter-wave radars 15, of the road (lane) on which the vehicle C1 is running at present and. The vehicle C1 acquires, as a center position LL of the lane, the center position LL of the measured width of the road (lane) (St2).

The vehicle C1 detects its running position using the GPS receiver 13 if the boundary lines LL1 or LL2 cannot be detected or neither of the boundary lines LL1 or LL2 can be detected by the camera 14 or the millimeter-wave radars 15 due to a road environment (e.g., it is raining, the road is shrouded in a thick mist, or it is night) (St1: no). The vehicle C1 detects a width of the road (lane) including a running position of the vehicle C1 by referring to map data on the basis of a running position of the vehicle C1 obtained on the basis of satellite positioning information received by the GPS receiver 13 (St3).

Where a current position of the vehicle C1 is detected using the GPS receiver 13, at step St2 the vehicle C1 acquires a width of the road (lane) using map data and acquires a center position LL on the basis of the acquired width of the road (lane).

The vehicle C1 acquires information of the width of the vehicle C1 that is set in the vehicle information detection unit 111b in advance (St4).

The vehicle C1 inputs the width of the road (lane), the center position LL of the lane acquired at step St3 and the width of the vehicle C1 acquired at step St4 to the offset estimation unit 112. The vehicle C1 estimates, by means of the offset estimation unit 112, a current offset on the basis of the difference between the center of the vehicle C1 in its width direction and the center position LL of the lane (St5).

The vehicle C1 inputs the width of the road (lane) and the center position LL of the lane acquired at step St3 and the width of the vehicle C1 acquired at step St4 to the offset calculation unit 113. The vehicle C1 calculates, by means of the offset calculation unit 113, a latest offset according to the center position LL of the lane on which the vehicle C1 is running at present and the width of the vehicle C1. The vehicle C1 calculates a steering amount in the width direction of the vehicle C1 on the basis of the latest offset calculated by the offset calculation unit 113 or the difference between the calculated latest offset and the current offset estimated by the offset estimation unit 112 (St6).

The vehicle C1 generates notification information relating to a steering control by means of the steering information generation unit 115 on the basis of the calculated steering amount. The vehicle C1 outputs the generated notification information to the output unit 19 (St7).

The vehicle C1 performs a steering control by means of the steering control unit 114 on the basis of the steering amount calculated at step St6 (St8). The steering control unit 114 generates control signals for steering the vehicle C1 in its width direction according to the calculated steering amount and drives the steering control unit 16, the brake control unit 17, and the accelerator control unit 18.

The vehicle C1 may execute a control process in which steps St7 and St8 of the example control process shown in FIG. 4 to be executed by the vehicle C1 according to the first embodiment are interchanged. This allows the vehicle C1 to perform safely a vehicle control for preventing formation of ruts according to the width of the road (lane) on which the vehicle C1 runs and the width of the vehicle C1.

As described above, the vehicle C1 according to the first embodiment which can run on a road including at least one lane detects boundary lines LL1 and LL2 of a running lane by means of the camera 14 which is an example of the term “boundary lines detection unit” and estimates a center position LL of the lane by means of the road information detection unit 111a on the basis of the detected boundary lines LL1 and LL2. The vehicle C1 calculates, by means of the offset calculation unit 113, a latest offset indicating a displacement in the vehicle width direction from the center position LL of the lane according to the estimated center position LL of the lane and a width of the vehicle C1 in such a manner that the latest offset varies dynamically. The vehicle C1 performs a steering control in the vehicle width direction on the basis of the latest offset by means of the steering control unit 114 which is an example of the term “vehicle control unit,” generates notification information for announcing the content of the steering control by means of the steering information generation unit 115 which is an example of the term “notification information generation unit,” and causes the output device 19 to output the generated notification information.

Configured as described above, the vehicle C1 can independently calculate and set an offset, suitable for it, from the center position LL of the lane and thereby prevent formation of ruts effectively. Furthermore, since the vehicle C1 generates and outputs notification information for announcing the content of a steering control, it is possible to announce the notification information to a driver or passenger of the vehicle C1 and thereby notify him or her of a running state of the vehicle C1 as a confirmation.

Furthermore, the vehicle C1 performs the steering control in the vehicle width direction on the basis of the difference between an offset calculated before and a calculated latest offset. With this measure, since the vehicle C1 independently calculates and sets a latest offset that is different from an offset calculated before, it is possible to suppress formation of ruts effectively.

The vehicle C1 is further equipped with the millimeter-wave radars 15 as sensors for detecting a road environment ahead of the vehicle C1, and the road information detection unit 111a detects each of the boundary lines LL1 and LL2 of the lane on the basis of outputs of the millimeter-wave radars 15. With this measure, using the millimeter-wave radars 15, the vehicle C1 can detect each of the boundary lines LL1 and LL2 of the lane even in a case that the camera 14 can detect neither of the boundary lines LL1 and LL2 because, for example, it is raining or it is night.

Still further, the vehicle C1 detects a running position of itself by means of the GPS receiver 13 which is an example of the term “boundary lines detection unit” and detects each of the boundary lines LL1 and LL2 in a running interval of the vehicle C1 including the detected running position using map data which is an example of preset pieces of “boundary line information” of respective roads. With this measure, the vehicle C1 can estimate a width of the road (lane) on which it is running and a lane center position LL even in the case where, for example, neither of the boundary lines LL1 and LL2 can be detected by the camera 14 or the millimeter-wave radars 15 or the road (lane) has no boundary lines LL1 and LL2. As such, the vehicle C1 can efficiently set its offset from the lane center position LL and thereby suppress formation of ruts.

### Introduction to Conception of Contents of Embodiment 2

In the conventional vehicle control system described in the first embodiment, the vehicle running on a road varies independently the displacement (offset) in the vehicle width direction from the center position LL of the lane on which the vehicle is running. However, it is sufficiently conceivable that, for example, plural vehicles are running on a road. Thus, it is preferable to be able to calculate offsets for performing steering controls for plural vehicles. Also in the above-mentioned Patent document 1, no consideration is given to calculating offsets of plural respective vehicles to enable steering controls on the respective vehicles.

In view of the above, in a second embodiment which is directed to a vehicle, a vehicle control system, and a vehicle control method, examples of a slip information control system and a slip information control method will be described that make it possible to set adaptively offsets suitable for respective vehicles from a center position LL of a lane according to a situation of a road concerned and thereby suppress formation of ruts.

### Embodiment 2

FIG. 5 is an explanatory diagram showing an example system configuration of a vehicle control system according to the second embodiment. The vehicle control system shown in FIG. 5 is configured so as to include a vehicle C1, a vehicle C2, and a server S1.

Each of the vehicles C1 and C2 can communicate with the server 51. Although FIG. 5 shows only one vehicle C2 to simplify the description, plural vehicles C2 may exist. Constituent elements shown in FIG. 5 and having the same ones in FIG. 2 will be described in a simplified manner or will not be described at all; only differences will be described. As in the first embodiment, a road that is used for describing the second embodiment has a lane on which each of the vehicle C1 and C2 is to run.

The vehicle C1 is equipped with a wireless communication unit 10 in addition to the configuration shown in FIG. 2. The wireless communication unit 10 is configured so as to include a radio circuit antenna Ant1 and is connected to a base station R1 (described later) so as to be able to perform a wireless communication with it. The wireless communication unit 10 transmits a width of the vehicle C1, a running position of the vehicle C1, and a current offset OF1 of the vehicle C1 to the server S1 via the base station R1 and a backbone network NW1. Furthermore, the wireless communication unit 10 receives, from the server S1, a latest offset OF1a calculated by the server S1.

The offset calculation unit 113 of the vehicle C1 of the vehicle control system shown in FIG. 5 transmits a running position of the vehicle C1, the width of the vehicle C1, and a current offset OF1 of the vehicle C1 to the server S1 at timing when the offset calculation unit 113 has received the current offset OF1 from the offset estimation unit 112 or timing when it has received a control signal for resetting the current offset OF1 from the offset estimation unit 112.

When receiving a latest offset OF1a of the vehicle C1 from the server S1, the offset calculation unit 113 output the latest offset OF1a of the vehicle C1 that has been set by the server S1 to the steering control unit 114 and stores the latest offset OF1a in the memory 32.

The base station R1 is a wireless base station used by a cellular network that is provided by an existing carrier. The base station R1 is connected to each of the vehicle C1 and the other vehicle C2 so as to be able to communicate with each of them over a wireless communication network N/W, and connected to the server S1 so as to be able to communicate with each of them over the backbone network NW1. The wireless communication network N/W is a network that is provided according to a wireless communication standard such as a wireless LAN (local area network), a wireless WAN (wide area network), a 4G (fourth generation mobile communication system), a 5G (fifth generation mobile communication system), or WiFi (registered trademark).

The backbone network NW1 is communicatably connected to each of the base station R1, the vehicle C1, the vehicle C2, and the server S1 through a wireless communication N/W (network).

Next, an example configuration of the vehicle C2 according to the second embodiment will be described with reference to FIG. 5. The vehicle C2 is configured so as to include a wireless communication unit 30, a control unit 31, a memory 32, a GPS receiver 33, a camera 34, millimeter-wave radars 35, a steering control unit 36, a brake control unit 37, an accelerator control unit 38, and an output unit 39.

The wireless communication unit 30 is configured so as to include a radio circuit antenna Ant4 and is connected to the base station R1 (described later) so as to be able to perform a wireless communication with it. The wireless communication unit 30 transmits a width of the vehicle C2, a running position of the vehicle C2, and a current offset OF2 of the vehicle C2 to the server S1 via the base station R1 and a backbone network NW1. Furthermore, the wireless communication unit 30 receives, from the server S1, a latest offset OF1a calculated by the server S1.

The control unit 31 have the same units as the control unit 11 of the vehicle C1 shown in FIG. 3 does. The control unit 31 performs various kinds of processing and control in a centralized manner by cooperating with the memory 32. For example, the control unit 31 is configured using an ECU which is an electronic circuit control device. More specifically, the control unit 31 realizes various functions of the respective units by referring to programs and data held by the memory 32 and running the programs. Like the control unit 11 (see FIG. 3) of the vehicle C1, the control unit 31 includes various units that are a detection unit (not shown), an offset estimation unit (not shown), an offset calculation unit (not shown), a steering control unit (not shown), and a steering information generation unit (not shown). The constituent units of the control unit 31 of the vehicle C2 are not shown in FIG. 5 because they are the same as the corresponding ones, shown in FIG. 3, of the control unit 11 of the vehicle C1.

The memory 32 has a RAM (random access memory) as a work memory that is used when, for example, the control unit 31 performs each kind of processing and a ROM (read-only memory) that stores programs that describe how the control unit 31 should operate and necessary data. The RAM is stored temporarily with data or information generated or acquired by the control unit 11. Programs that describe operations of the control unit 31 (e.g., an operation of estimating a current offset OF2 of the vehicle C2 from offsets that were calculated in the past and an operation of calculating a latest offset OF2a on the basis of a center position LL of the lane on which the vehicle C2 is running at present and the width of the vehicle C2) are written in the ROM. The memory 32 is stored with a type, a width, a current offset OF2, etc. of the vehicle C2.

The GPS receiver 33, which is an example of the term “boundary lines detection unit,” includes a satellite positioning antenna Ant5, and receives satellite positioning signals from artificial satellites (not shown) and detects a running position of the vehicle C2. The GPS receiver 33 outputs information of the detected position of the vehicle C2 to the detection unit (not shown). Signals that can be received by the GPS receiver 33 are not limited signals of GPS (Global Positioning System) of the U.S. and may be, for example, signals that are transmitted from artificial satellites that can provide a satellite positioning service such as GLONASS (Global Navigation Satellite System) of Russia or Galileo of Europe. Furthermore, the GPS receiver 33 may receive signals from quasi-zenith satellites that transmit satellite positioning signals capable of reinforcing or correcting satellite positioning signals transmitted from the artificial satellites that provide one of the above satellite positioning services.

The camera 34, which is an example of the term “boundary lines detection unit,” shoots each of boundary lines LL1 and LL2 of the road (lane) on which the vehicle C2 is running. The camera 34 is capable of performing image processing using data of an image taken, and detects presence/absence of each of boundary lines LL1 and LL2 by the image processing and detects a distance between the detected boundary lines LL1 and LL2 (in other words, a road width within which the vehicle C2 can run). The camera 34 detects a detection result of each of the detected boundary lines LL1 and LL2 and the detected distance between the boundary lines LL1 and LL2.

The millimeter-wave radars 35, which are an example of the term “boundary lines detection unit,” are installed in the vehicle C2 at bottom-front positions and detect respective boundary lines LL1 and LL2 of the road (lane) on which the vehicle C2 is running. The millimeter-wave radars 35 output detection results of the respective boundary lines LL1 and LL2 to the detection unit (not shown).

The detection unit (not shown) includes a road information detection unit (not shown) and a vehicle information detection unit (not shown). The detection unit acquires information of a running position of the vehicle C2 that is input from the GPS receiver 33 and information relating to the boundary lines LL1 and LL2 of the road (lane) on which the vehicle C2 is running (more specifically, whether each of the boundary lines LL1 and LL2 exists and a road width within which the vehicle C2 can run that is determined on the basis of a distance between the boundary lines LL1 and LL2) that is input from the camera 34 or the millimeter-wave radars 35.

The road information detection unit (not shown), which is an example of the term “center position estimation unit” (in the vehicle C2), detects information relating to the road on which the vehicle C2 is running on the basis of data or information that is input from each (set of) of the GPS receiver 33, the camera 34, and the millimeter-wave radars 35. More specifically, the information relating to the road is information including position information of the road and a width of the road (lane). The road information detection unit outputs the detection results to the offset estimation unit (not shown).

Furthermore, the road information detection unit (not shown) may be stored with map data including information relating to roads on which the vehicle C2 may run and geographical features around them. The map data may be either stored in the memory 32 of the vehicle C2 or acquired from a server (not shown) stored with map data over the wireless communication N/W using the radio circuit antenna Ant4 when it is used. The term “map data” as used herein includes at least information relating to roads and intersections, and the information relating to roads is stored on a section-by-section basis. For example, the information relating to roads may include information such as the number of lanes of each road and widths of each road and boundary lines of each road (lane), and may have information of a width of each road within which a vehicle can run in the case where the road does not have boundary lines.

A method by which the road information detection unit (not shown) of the vehicle C2 detects information relating to the road on which the vehicle C2 is running on the basis of the contents of data or information that is input from related units, that is, the GPS receiver 33, the camera 34, and the millimeter-wave radars 35, will be described below.

The road information detection unit (not shown) of the vehicle C2 detects information relating to the road on which the vehicle C2 is running by referring to the map data on the basis of a running position of the vehicle C2 acquired from satellite positioning information received from the GPS receiver 33. The road information detection unit estimates a center position LL of the lane from the detected information relating to the road. A center position LL of the lane is estimated by referring to the distance between the boundary lines LL1 and LL2 or the above-mentioned map data. The road information detection unit can estimate a center position LL of the lane even in the case where the road has only one of the boundary lines LL1 and LL2 or has no boundary lines if the map data includes information of road widths in advance.

Furthermore, the road information detection unit (not shown) estimates a center position LL of the lane on which the vehicle C2 is running on the basis of the distance between the boundary lines LL1 and LL2 that has been input from the camera 34.

The road information detection unit (not shown) of the vehicle C2 estimates a center position LL of the lane on which the vehicle C2 is running also on the basis of the distance between the boundary lines LL1 and LL2 that has been input from the millimeter-wave radars 35. The road information detection unit can estimate a center position LL of the lane on the basis of detection results of the millimeter-wave radars 35 even in the case where the road has only one of the boundary lines LL1 and LL2 or has no boundary lines, and can estimate a center position LL on the basis of an estimation result.

The road information detection unit (not shown) of the vehicle C2 can estimate a center position LL of the lane in the above-described manner. The method by which the road information detection unit estimates a center position LL of the lane is not limited to the above-described example. For example, the road information detection unit may estimate a center position LL of the lane by detecting position information of the vehicle by means of the GPS receiver 33 and detecting boundary lines LL1 and LL2 by means of the respective millimeter-wave radars 35. Furthermore, to secure necessary reliability of a detection result, the road information detection unit may configured so as to be able to select a detection method that is suitable for a road environment (e.g., it is raining, the road is shrouded in a thick mist, or it is night) in which the vehicle C2 is running or employ a detection method that uses the camera 34 and the millimeter-wave radars 35 in combination.

The vehicle information detection unit (not shown) of the vehicle C2 detects information relating to the vehicle C2 including a preset type and width of the vehicle C2. The vehicle information detection unit (not shown) of the vehicle C2 may be stored with, for example, information of a road interval over which the vehicle C2 has run with a current offset OF2 obtained on the basis of offsets calculated before. The vehicle information detection unit outputs the detected information relating to the vehicle C2 to the offset estimation unit (not shown). The information relating to the vehicle C2 including its type, width, etc. may be stored in the memory 32.

The “road interval” mentioned above may be either a prescribed interval that is one of intervals divided off every different road width or a prescribed interval that is one of intervals divided off every prescribed distance. Or the road interval may be a prescribed interval that is one of intervals divided off every different road width of a road type (e.g., national road, prefectural road, or private road) or a prescribed interval that is one of intervals divided off every prescribed distance, or an interval obtained every time an intersection having traffic lights appears.

The offset estimation unit (not shown) of the vehicle C2 receives information relating to roads from the road information detection unit (not shown) of the vehicle C2 and receives information relating to the vehicle C2 from the vehicle information detection unit (not shown). The offset estimation unit estimates a current offset OF2 on the basis of these received pieces of information according to the difference between a center position LL of the lane on which the vehicle C2 is running at present and the center of the vehicle C2 in its width direction.

Furthermore, the offset estimation unit (not shown) of the vehicle C2 may judge whether the vehicle C2 can run with the current offset on the basis of the information relating to roads from the road information detection unit (not shown) of the vehicle C2 and the information relating to the vehicle C2 received from the vehicle information detection unit (not shown) of the vehicle C2. The offset estimation unit 112 can calculate a maximum offset value with which the vehicle C2 can run on the basis of the received road width and width of the vehicle C2. If judging that the current offset OF2 is larger than the calculated offset with which the vehicle C2 can run, the offset estimation unit 112 outputs, to the offset calculation unit (not shown), a control signal for causing it to calculate a latest offset OF2a.

If a destination, route information, or the like is set in advance in a navigation device (not shown) installed in the vehicle C2, the offset estimation unit (not shown) of the vehicle C2 may judge whether the vehicle C2 can run in a state that the current offset OF2 is maintained for a route candidate that is predictable as a route the vehicle C2 will take. If the judgment result is “impossible to run so,” the offset estimation unit outputs, to the offset calculation unit (not shown) of the vehicle C2, a control signal for causing it to calculate a latest offset OF2a for the route candidate. This allows the vehicle C2 to continue to run safely without running in such a manner as to stick out of the current road, running on a side strip such as gutter lids of the road, or running in a similar manner even in a case that the width of a road to run on has decreased. Furthermore, the offset estimation unit 112 may judge whether the vehicle C2 can run on a road interval ahead that follows the current road interval in a state that the preceding offset is maintained.

Furthermore, when the vehicle C2 is running on a road having no boundary lines or having only one of the boundary lines LL1 and LL2, the offset estimation unit (not shown) of the vehicle C2 may output, to the offset calculation unit (not shown), a control signal for causing it to reset the offset (in other words, make the offset equal to 0). This allows the vehicle C2 to continue to run safely even in a case that a road width is unknown. A road having no boundary lines or having only one of the boundary lines LL1 and LL2 may be detected by or using one of the GPS receiver 33, the camera 34, the pair of millimeter-wave radars 35, and the map data.

The timing when the above-mentioned offset estimation unit (not shown) of the vehicle C2 estimates an offset may be not only timing when information relating to roads and information relating to the vehicle C2 are input to it but also, for example, timing when the vehicle C2 has passed a point that is set in the map data in advance (e.g., timing when the vehicle C2 has passed a point of position information represented by a latitude and longitude or timing when as for the above-mentioned prescribed interval switching is made from the prescribed interval in which the vehicle C2 is running currently to another prescribed interval).

The offset calculation unit (not shown) of the vehicle C2 transmits a running position of the vehicle C2, the width of the vehicle C2, and the current offset OF2 of the vehicle C2 to the server S1 at timing when it has received the current offset OF2 from the offset estimation unit (not shown) of the vehicle C2 or it has received a control signal for resetting the current offset OF2 from the offset estimation unit.

When receiving a latest offset OF2a for the vehicle C2 from the server S1, the offset calculation unit (not shown) of the vehicle C2 outputs the latest offset OF2a for the vehicle C2 that has been set by the server S1 to the steering control unit (not shown) of the vehicle C2 and has it stored in the memory 32. If no latest offset OF2 has been set by the server S1 (described later) (e.g., no running vehicle exists within a prescribed distance of the vehicle C2), the offset calculation unit of the vehicle C2 calculates a latest offset OF2a by performing the same operation as the offset calculation unit 113 of the vehicle C1 performs (described above with reference to FIG. 3)

The steering control unit (not shown) of the vehicle C2 calculates a steering amount with which to perform a steering control on the basis of a latest offset OF2a received newly or the difference between the latest offset OF2a and a current offset OF2. The steering control unit generates control signals for execution of steering controls on the vehicle C2 on the basis of the calculated steering amount. The control signals are transmitted to a steering actuator of the steering control unit 36, a brake actuator of the brake control unit 37, and an accelerator actuator of the accelerator control unit 38, respectively.

The steering control unit 36 performs a steering control according to the latest offset OF2a or the difference between the latest offset OF2a and the current offset OF2 in the control signal generated by the steering control unit (not shown) of the vehicle C2. In other words, the steering control unit 36 performs a steering control so as to decrease the difference between the latest offset OF2a and the current offset OF2 to 0.

The brake control unit 37 performs deceleration processing that is necessary for the steering control that is performed according to the calculated latest offset OF2a or the difference between the latest offset OF2a and the current offset OF2 in the control signal generated by the steering control unit (not shown) of the vehicle C2.

The accelerator control unit 38 performs acceleration processing that is necessary for the steering control that is performed according to the calculated latest offset OF2a or the difference between the latest offset OF2a and the current offset OF2 in the control signal generated by the steering control unit (not shown) of the vehicle C2.

The steering information generation unit (not shown) of the vehicle C2, which is an example of the term “notification information generation unit,” generates notification information relating to the steering control over the vehicle C2 on the basis of the steering amount calculated by the steering control unit (not shown) of the vehicle C2. The steering information generation unit outputs the generated notification information to the output unit 39 to announce it. For example, to steer the vehicle C2 to the left of the center position LL of the lane by the steering control, the steering information generation unit generates and outputs notification information as shown in FIGS. 8 and 9B. The generated notification information of the steering control is not limited to an image or a text and may include a voice.

The output unit 39 makes an announcement by outputting the received notification information relating to the steering control. Equipped with a monitor capable of displaying an image, the output unit 39 announces the notification information in the form of an image including text information. The output unit 39 may be equipped with a speaker capable of voice output and announce the notification information in the form of a voice. Example manners of output of notification information will be described later.

Next, the configuration of the server S1 will be described with reference to FIG. 5.

The server S1 can communicate with each of the vehicles C1 and C2 via the base station R1 and the backbone network NW1. The server S1 is configured so as to include a wireless communication unit 20, a control unit 21, a memory 22, and a control signal generation unit 23.

The wireless communication unit 20 has a radio circuit antenna Ant3 and is configured using a communication interface circuit for transmitting and receiving data or information to and from each of the vehicles C1 and C2 via the base station R1 or the backbone network NW1. The wireless communication unit 20 receives information of a width, information of a running position, and information of a current offset OF1 or OF2 of each of the vehicles C1 and C2. Furthermore, the wireless communication unit 20 transmits latest offsets OF1a and OF2a for the respective vehicles C1 and C2 that have been set by an offset setting unit 212 (described later) to the respective vehicles C1 and C2 via the base station R1 and the backbone network NW1.

The control unit 21 performs various kinds of processing and control in cooperation with the memory 22. For example, the control unit 21 is configured using a processor such as a CPU, a DSP, or an FPGA (field-programmable gate array). More specifically, the control unit 21 realizes a function of each of an offsets collection unit 211 and the offset setting unit 212 by referring to programs and data held by the memory 22 and running the programs.

The offsets collection unit 211 collects pieces of vehicle information (e.g., pieces of vehicle width information, pieces of running position information, and pieces of information of current offsets OF1 and OF2) of the vehicles C1 and C2 received from them. The offsets collection unit 211 judges whether the vehicle C2 is running in a road interval including a running position of the vehicle C1 and whether the vehicle C2 is running in a range of a prescribed distance from the vehicle C1 on the basis of the pieces of running position information of the vehicles C1 and C2. If judgment results are that the vehicle C2 is running in the road interval including a running position of the vehicle C1 and the vehicle C2 is running in the range of the prescribed distance from the vehicle C1, the offsets collection unit 211 outputs the collected pieces of vehicle information (described above) of the vehicles C1 and C2 to the offset setting unit 212.

Pieces of vehicle information (mentioned above) collected by the offsets collection unit 211 are not limited to those of the two vehicles C1 and C2 shown in FIG. 5 and may be pieces of vehicle information of vehicles that can be controlled by the vehicle control system. The above-mentioned road interval and prescribed distance are set by a manager of the vehicle control system in advance and can be changed by him or her.

The offset setting unit 212 sets latest offsets OF1a and OF2a for the respective vehicles C1 and C2 on the basis of the pieces of vehicle information (e.g., pieces of vehicle width information, pieces of running position information, and pieces of information of current offsets OF1 and OF2) of the vehicles C1 and C2 received from the offsets collection unit 211. The offset setting unit 212 compares the pieces of information of current offsets OF1 and OF2 of the vehicles C1 and C2 and calculates and sets latest offsets OF1 a and OF2a so that they will have a difference that is larger than or equal to a prescribed value. The offset setting unit 212 calculates latest offsets OF1a and OF2a according to road width information that is obtained on the basis of running positions of the respective vehicles C1 and C2 and vehicle width information of the respective vehicles C1 and C2. The offset setting unit 212 stores the thus-set latest offsets OF1a and OF2a of the respective vehicles C1 and C2 in the memory 22 and outputs them to the control signal generation unit 23.

The memory 22, which is an example of the term “storage unit,” has a RAM as a work memory that is used when, for example, the control unit 21 performs each kind of processing and a ROM that stores programs that describe how the control unit 21 should operate and necessary data. The RAM is stored temporarily with data or information generated or acquired by the control unit 21. Programs that describe operations of the control unit 21 (e.g., a method for setting latest offsets OF1a and OF2a of the respective vehicles C1 and C2) are written in the ROM. The memory 22 is stored with, for each prescribed road interval, the pieces of vehicle width information of the respective vehicles C1 and C2, the pieces of running position information of the respective vehicles C1 and C2, and the pieces of current offsets OF2 of the respective vehicles C1 and C2 received from the respective vehicles C1 and C2.

The control signal generation unit 23 generates control signals for controlling the respective vehicles C1 and C2 on the basis of the latest offsets OF1a and OF2a that have been set by the offset setting unit 212. The control signal generation unit 23 transmits the generated control signals to the wireless communication units 10 and 30 of the vehicles C1 and C2, respectively, from the wireless communication unit 20.

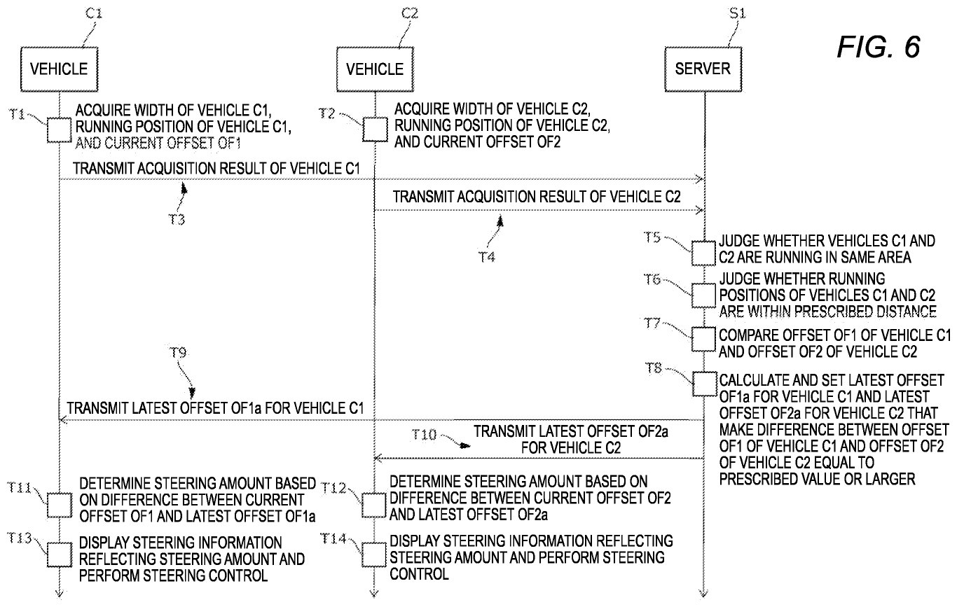

FIG. 6 is a sequence diagram showing an example control process of the vehicle control system according to the second embodiment. Although FIG. 6 shows only the two vehicles C1 and C2 to simplify the description, in the vehicle control system according to the second embodiment the number of vehicles is not limited to two.

The vehicle C1 acquires pieces of information, that is, a vehicle width, a running position, and a current offset OF1 of the vehicle C1, on the basis of a detection result(s) of the GPS receiver 13, the camera 14, or the millimeter-wave radars 15 and pieces of information relating to the vehicle C1 that are stored in the vehicle information detection unit 111b or the memory 12 (T1).

The vehicle C2 acquires pieces of information, that is, a vehicle width, a running position, and a current offset OF2 of the vehicle C2, on the basis of a detection result(s) of the GPS receiver 33, the camera 34, or the millimeter-wave radars 35 and pieces of information relating to the vehicle C2 that are stored in the vehicle information detection unit (not shown) of the vehicle C2 or the memory 32 (T2).

The vehicle C1 transmits acquisition results of step T1 to the server S1 via the base station R1 and the backbone network NW1 (T3).

The vehicle C2 transmits acquisition results of step T2 to the server S1 via the base station R1 and the backbone network NW1 (T4).

The server S1 judges whether the vehicles C1 and C2 are running in a prescribed interval (area) of the same road on the basis of the acquisition results received from the vehicles C1 and C2 (T5). The prescribed interval of the road is set in advance by the manager of the vehicle control system.

If judging at step T5 that the vehicles C1 and C2 are running in the prescribed interval (area) of the same road, the server S1 further judges whether the vehicles C1 and C2 are running in a range of a prescribed distance (T6). Different prescribed distance may be set by the manager of the vehicle control system in advance for respective prescribed intervals.

If judging that the vehicles C1 and C2 are running in a range of the prescribed distance, the server S1 refers to current offsets OF1 and OF2 of the respective vehicles C1 and C2 among the acquisition results and compares them (T7).

The server S1 sets latest offsets OF1a and OF2a for the respective vehicles C1 and C2 so that their difference becomes larger than or equal to a prescribed value on the basis of widths of roads on which the respective vehicles C1 and C2 are running and widths of the respective vehicles C1 and C2 (T8).

The server S1 transmits the thus-set latest offset OF1a for the vehicle C1 to the vehicle C1 via the base station R1 and the backbone network NW1 (T9).

The server S1 transmits the thus-set latest offset OF2a for the vehicle C2 to the vehicle C2 via the base station R1 and the backbone network NW1 (T10).

The vehicle C1 determines a steering amount for causing the steering control unit 114 to perform a steering control, on the basis of the difference between the latest offset OF1a received from the server S1 and the current offset OF1 (T11).

The vehicle C2 determines a steering amount for causing the steering control unit (not shown) of the vehicle C2 to perform a steering control, on the basis of the difference between the latest offset OF2a received from the server S1 and the current offset OF2 (T12).

In the vehicle C1, the steering information generation unit 115 generates steering information (notification information) relating to the steering control on the basis of the steering amount determined at step T11. The vehicle C1 causes the output unit 19 to display the generated steering information and causes the steering control unit 114 to perform the steering control (T13).

In the vehicle C2, the steering information generation unit (not shown) of the vehicle C2 generates steering information (notification information) relating to the steering control on the basis of the steering amount determined at step T12. The vehicle C2 causes the output unit 39 to display the generated steering information and causes the steering control unit (not shown) of the vehicle C2 to perform the steering control (T14).

The control process of the vehicle control system is not limited to the example control process shown in FIG. 6. For example, steps T1 and T2, steps T3 and T4, steps T9 and T10, or steps T11 and T12 are controls performed by the respective vehicles C1 and C2, either one of each pair of steps may be executed first. This also applies to a case that the number of vehicles involved is increased.

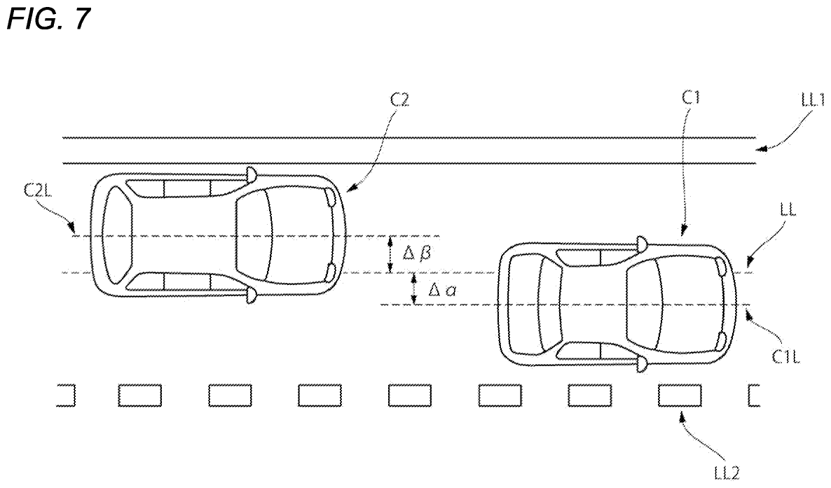

FIG. 7 is an explanatory diagram showing an example steering control. As shown in FIG. 7, the vehicles C1 and C2 are running on a road having boundary lines LL1 and LL2 and are in a state that they have received latest offsets and performed steering controls, respectively. A center position LL of the lane is a position estimated on the basis of boundary lines LL1 and LL2. An offset Δα is set in the vehicle C1 as a latest offset OF1a. An offset Δβ is set in the vehicle C2 as a latest offset OF2a.

The vehicle C1 shown in FIG. 7 in which the offset Δα is set as the latest offset OF1a and is performing a steering control so that the vehicle C1 runs with its center in the vehicle width direction located at a position CIL that is displaced from the center position LL of the lane in the vehicle width direction by the offset Δα . On the other hand, the vehicle C2 in which the offset Δβ is set as the latest offset OF2a and is performing a steering control so that the vehicle C2 runs with its center in the vehicle width direction located at a position C2L that is displaced from the center position LL of the lane in the vehicle width direction by the offset Δβ. The difference between the positions of the vehicles C1 and C2 in the vehicle width direction that is calculated on the basis of the offsets Δα and Δβ is larger than or equal to the prescribed value mentioned at step T8 in FIG. 6. That is, (Δα+Δβ) is larger than or equal to the prescribed value mentioned at step T8 in FIG. 6.

FIG. 8 shows an example manner of output of notification information. The notification information shown in FIG. 8 is information generated so as to include text information or voice information for conveying the content of the notification information. The steering information generation units of the vehicles C1 and C2 generate pieces of notification information relating to steering controls to be performed on the basis of steering amounts, respectively, and output the generated pieces of notification information to the output units 19 and 39 of the vehicles C1 and C2, respectively. The output units 19 and 39 output, that is, announce the respective received pieces of notification information.

As shown in FIG. 8, each of the output units 19 and 39 is equipped with a display area Sr1. Each of the output units 19 and 39 displays notification information Msg1 using all or part of the display area Sr1 and thereby announces the notification information relating to the steering control to a driver or passenger of the vehicle C1 or C2. Alternatively, each of the output units 19 and 39 may be equipped with a speaker and announce the notification information in the form of a voice.

FIG. 9A shows an example manner of output of notification information (center position). Notification information Nt1 shown in FIG. 9A is generated so as to include an image or a voice and is displayed in a display area Sr2. The notification information Nt1 includes a line indicating the center position LL of the lane and an icon of the vehicle indicating that it is running on the road. The notification information Nt1 shown in FIG. 9A indicates that a steering control will be performed so that the vehicle will run, for example, at the center position LL of the lane, and is displayed in, for example, a case of performing a steering control so as to reset the offset (i.e., makes it equal to 0) for, for example, a reason that the vehicle width is large for the road width.

FIG. 9B shows an example manner of output of notification information (leftward displacement). Notification information Nt2 shown in FIG. 9B is generated so as to include an image or a voice and is displayed in a display area Sr3. The notification information Nt2 includes a line indicating the center position LL of the lane, an icon of the vehicle indicating that it is running on the road, and an icon Ic1 indicating a steering direction of a steering control. The notification information Nt2 shown in FIG. 9B indicates, by the icon Ic1, that a steering control will be performed so that the vehicle will be displaced leftward, that is, toward the left side of the center position LL of the lane, on the basis of a latest offset.

FIG. 9C shows an example manner of output of notification information (rightward displacement). Notification information Nt3 shown in FIG. 9C is generated so as to include an image or a voice and is displayed in a display area Sr4. The notification information Nt3 includes a line indicating the center position LL of the lane, an icon of the vehicle indicating that it is running on the road, and an icon Ic2 indicating a steering direction of a steering control. The notification information Nt3 shown in FIG. 9C indicates, by the icon Ic2, that a steering control will be performed so that the vehicle will be displaced rightward, that is, toward the right side of the center position LL of the lane, on the basis of a latest offset.

As described above, the vehicle control system according to the second embodiment is a vehicle control system in which the vehicle C1 and the server S1 can communicate with each other. The vehicle C1 detects information relating to a running position on a road on which the vehicle C1 is running and boundary lines LL1 and LL2 of a lane on which the vehicle is running, and estimates a center position LL of the lane on the basis of the detected boundary lines. The vehicle C1 calculates a current offset OF1 indicating a displacement in the vehicle width direction from the center position LL of the lane according to the estimated center position LL of the lane and a vehicle width of the vehicle C1, and transmits, to the server S1, vehicle information including the information relating to the running position of the vehicle C1 and the calculated current offset. The server S1 acquires vehicle information of another vehicle C2 running in a range of a prescribed distance from the vehicle C1 in a running interval including the received running position of the vehicle C1, calculates a latest offset OF1a (an example of the term “updated offset”) that makes the difference between the current offset OF1 corresponding to the vehicle C1 and the current offset OF2 corresponding to the other vehicle C2 included in vehicle information of the other vehicle C2 larger than or equal to a prescribed value, and transmits the latest offset to the vehicle C1. The vehicle C1 performs a steering control on itself on the basis of the received updated offset OF1a.

Configured as described above, the vehicle control system according to the second embodiment can set offsets adaptively for plural vehicles running in a prescribed interval of the same road according to a situation of the road. This makes it possible to distribute deterioration positions of the road more effectively and hence suppress formation of ruts.

When the updated offset OF1a has been set, the vehicle C1 generates notification information for announcing the content of the steering control and announces it. With this measure, the vehicle C1 can announce the notification information relating to the steering control to a driver or passenger of the vehicle C1.

Other examples of individual constituent elements of the first embodiment and the second embodiment will be described below.

The road relating to each of the first embodiment and the second embodiment is not limited to a general road and may be an expressway or a private road. This makes it possible to lower the load on maintenance and preservation of social infrastructure involving whole roads. Even in a case that ruts are already formed on a road, the probability of occurrence of accidents involving a vehicle due to worsening of the ruts (in other words, deepening of the ruts) can be prevented.

A vehicle relating to the first embodiment or each vehicle relating to the second embodiment may be either a vehicle that is drive-controlled by a person or an autonomous drive vehicle. In the case of an autonomous drive vehicle, a related autonomous driving level may be any of autonomous driving levels 2-5 prescribed by [ ]. In addition, the vehicle may be a bus, a truck, a golf cart that runs in a golf course, or the like.

The vehicle C1 according to the first embodiment may calculate a latest offset on the basis of history data of offsets that were calculated before every prescribed interval of roads and then set. The history data are stored in the offset estimation unit 112 or the memory 12. For example, among the offsets in the history data, the vehicle C1 may set, as a latest offset, an offset that is small in the number of times of running.

The server S1 according to the second embodiment may generate history data using offsets that were calculated before every prescribed interval of roads and then set and offsets that are collected from running vehicles every prescribed interval of roads. On the basis of the generated history data, the server S1 may calculate a latest offset for each of plural vehicles running in a prescribed interval of roads. The history data are stored in the memory 22. The server S1 may set offsets with preference given to road surfaces for which latest offsets set for respective vehicles have a difference that is larger than or equal to a prescribed value and the number of times of running is judged small on the basis of history data. Furthermore, where only one vehicle is running in a prescribed interval of a road or plural vehicles are not found that are running in a range of a prescribed distance, the server S1 may set offsets with preference given to road surfaces that are small in the number of times of running on the basis of history data.

Although the various embodiments have been described above with reference to the accompanying drawings, the concept of the disclosure is not limited to those examples. It is apparent that various changes, modifications, replacements, additions, deletions, and equivalents can be conceived, and they are also construed as belonging to the technical scope of the disclosure. Furthermore, constituent elements of the above-described various embodiments may be combined in a desired manner without departing from the spirit and scope of the invention.

The disclosure is useful because it provides a vehicle, a vehicle control system, and a vehicle control method capable of suppressing formation of ruts by setting adaptively an offset from the center position of a current lane of the road that is suitable for each running vehicle and presenting a running state to the driver.

The present application is based on Japanese Patent Application No. 2019-064865 filed on Mar. 28, 2019, the disclosure of which is incorporated herein by reference.

1. A vehicle configured to run on a road including at least one lane, the vehicle comprising:
a processor;
a memory having instructions; and
an output device,
wherein the instructions, when executed by the processor, cause the vehicle to perform operations, the operations comprising:
detecting a boundary line of a lane on which the vehicle is running;
estimating a center position of the lane on which the vehicle is running on a basis of the boundary line;
calculating an offset indicating a displacement in a vehicle width direction from the center position of the lane in accordance with the center position of the lane and a vehicle width such that the offset varies dynamically;
performing a steering control in the vehicle width direction on a basis of the offset;
generating notification information for announcing a content of the steering control; and
causing the output device to output the notification information.

2. The vehicle according to claim 1,
wherein the steering control in the vehicle width direction is performed on a basis of a difference between an offset calculated before and a calculated latest offset.

3. The vehicle according to claim 1, further comprising:
a sensor configured to detect a road environment ahead of the vehicle,
wherein the boundary line is detected on a basis of an output of the sensor.

4. The vehicle according to claim 1, wherein the detecting the boundary line comprises:
detecting a running position of the vehicle; and
detecting boundary line information in a running interval of the vehicle including the running position using pieces of lane boundary line information of respective preset roads.

5. A vehicle control method of a vehicle configured to run on a road including at least one lane, the vehicle control method comprising:
detecting a boundary line of a lane on which the vehicle is running;
estimating a center position of the lane on a basis of the boundary line;
calculating an offset indicating a displacement in a vehicle width direction from the center position of the lane in accordance with the center position of the lane and a vehicle width such that the offset varies dynamically;
performing a steering control in the vehicle width direction on a basis of the offset; and
generating notification information for announcing a content of the steering control and outputting the notification information.

6. A vehicle control system comprising:
a vehicle comprising a first processor, a first memory having first instructions, and a first communication device, the vehicle being configured to run on a road having at least one lane; and
a server comprising a second processor, a second memory having second instructions, and a second communication device configured to communicate with the first communication device,
wherein the first instructions, when executed by the first processor, cause the vehicle to perform first operations, the first operations comprising:
detecting information relating to a running position on a road on which the vehicle is running and a boundary line of the a lane of the road;
estimating a center position of the lane on a basis of the boundary line;
calculating an offset indicating a displacement in a vehicle width direction from the center position of the lane in accordance with the center position of the lane and a vehicle width of the vehicle;
generating vehicle information comprising the information relating to the running position of the vehicle and the calculated offset; and
causing the first communication device to transmit the vehicle information to the server,
wherein the second instructions, when executed by the second processor, cause the server to perform second operations, the second operations comprising:
acquiring vehicle information of another vehicle running in a range of a prescribed distance from the vehicle in a running interval including the running position of the vehicle, the running position being received via the second communication device;
calculating an updated offset containing a difference between the offset corresponding to the vehicle and an offset corresponding to the another vehicle included in the vehicle information of the another vehicle, the difference being larger than or equal to a prescribed value; and
causing the second communication device to transmit the updated offset to the vehicle, and
wherein the first operations further comprise performing a steering control on the vehicle on a basis of the updated offset received via the first communication device.

7. The vehicle control system according to claim 6, wherein the first operations further generate notification information for announcing a content of the steering control.

8. A vehicle control method performed by a vehicle control system in which a vehicle configured to run on a road including at least one lane and a server are configured to communicate with each other, the vehicle control method comprising:
detecting information relating to a running position on a road on which the vehicle is running and a boundary line of a lane of the road;
estimating a center position of the lane on the a basis of the boundary line;
acquiring an offset indicating a displacement in a vehicle width direction from the center position of the lane;
acquiring current vehicle information of another vehicle that is running in a range of a prescribed distance from the vehicle in a running interval including the running position of the vehicle;
calculating an updated offset containing a difference between the offset corresponding to the vehicle and an offset corresponding to the another vehicle included in the vehicle information of the another vehicle, the difference being larger than or equal to a prescribed value; and
performing a steering control on the vehicle on a basis of the updated offset.

9. The vehicle according to claim 1,
wherein the offset comprises a future offset with respect to a scheduled road interval comprising a running position at which the vehicle is scheduled to run.

10. The vehicle according to claim 9,
wherein the operations further comprise determining whether the latest offset is maintained on a basis of the future offset.

11. The vehicle according to claim 9,
wherein the operations further comprise estimating the scheduled road interval on a basis of a destination or route information set in advance.

12. The vehicle according to claim 1,
wherein the operations further comprise calculating a maximum offset value that allows the vehicle to run on a basis of a width of the lane on which the vehicle is running and the vehicle width, and
wherein the offset is calculated so as to fall within a range not to exceed the maximum offset value.

13. The vehicle according to claim 1,
wherein the operations further comprise:
calculating a maximum offset value that allows the vehicle to run on a basis of a width of the lane on which the vehicle is running and the vehicle width; and
determining whether the maximum offset value is larger than a latest offset, and
wherein the calculating the offset is performed in response to a determination result indicating that the maximum offset value is larger than the latest offset.

14. The vehicle according to claim 1,
wherein the operations further comprise resetting the offset in response to a detection of the boundary line being unavailable.

15. The vehicle according to claim 2,
wherein the steering control is performed so as to decrease the difference between the offset calculated before and the calculated latest offset to zero.

16. The vehicle according to claim 3,
wherein the sensor comprises a camera.

17. The vehicle according to claim 3,
wherein the sensor comprises a millimeter-wave radar.

18. The vehicle according to claim 3, further comprising:
a GPS receiver,
wherein the boundary line is detected on a basis of information of a running position of the vehicle input from the GPS receiver and the output of the sensor.

19. The vehicle according to claim 3,
wherein the road environment contains a road width, and
wherein the calculating the offset is performed in response to detection of change of the road width.

20. The vehicle according to claim 4,
wherein the operations further comprise acquiring map data, and
wherein the boundary line information is acquired from the map data.
